(19) United States
(12) Patent Application Publication
(10) Pub. No.: US 2012/0173443 A1
(43) Pub. Date: Jul. 5, 2012

(54) METHODOLOGY FOR DETERMINATION OF THE REGULATORY COMPLIANCE LEVEL

(76) Inventors: MAXYM GERASHCHENKO, Heidelberg (DE); Olga Mordvinova, Heidelberg (DE)

(21) Appl. No.: 12/980,372

(22) Filed: Dec. 29, 2010

(51) Int. Cl. G06Q 99/00

(52) U.S. Cl. 705/317

(57) ABSTRACT

Various embodiments of systems and methods for determination of the regulatory compliance level are described herein. The method uses a single set of controls as a basis for calculation of compliance to different regulations. Scale based definition of controls, joined with requirements matrix, allows flexible integration of a new regulation without changes on controls itself. The decoupling of requirements from controls and definition of the implementation scale enables independent reporting about control implementation without considering of regulatory requirements. Therefore, one reporting round, which provides status of controls implementation, can be used for calculation of compliance to many regulations.

### FIELD

The field generally relates to the software arts, and, more specifically, to methods and systems for determination of the regulatory compliance level.

### BACKGROUND

Large enterprises have to fulfill a lot of regulations. There are different international and governmental laws and standards, which require different levels of quality, security, service, documentation, and far more objectives. For example, Sarbanes—Oxley Act (SOX), German Arbeitsschutzgesetz (ArbSchG), Betriebssicherheitsverordnung (BetrSichV), Telekommunikationsgesetz (TKG). Not fulfilling these regulations could lead to limitation of business operation, penalties, and impact the market price or customer confidence. Also, the tracking of enterprise internal policies and voluntary international standards like ISO is advisable. This should confirm sustainability, quality strive of a company, and transparency about business internal controls. Compliance with the ISO standard could be used for a public announcement regarding quality level in a specific area. The measurement of compliance level to, e.g., internal Security Policy of an enterprise reflects the progress by achievement of the decided security level in a company. An efficient control management is required to ensure effectiveness of business processes. Methodology and standards for control management could enlarge the market segment and increase customer interest.

### SUMMARY

Various embodiments of systems and methods for methodology for determination of the regulatory compliance level are described herein. In an embodiment, the method includes receiving a selection of criteria for compliance level calculation, wherein the criteria include at least one regulation. At least one control applicable for the regulation is determined, the control defined with a required implementation level for the regulation in a requirements matrix. The method also includes determining an implementation status of the control for the regulation. Further, it is determined if the implementation status of the control corresponds to the required implementation level for the regulation. Finally, in response to the determination if the implementation status corresponds to the required implementation level, a first total number of compliant controls, a second total number of non-compliant controls, and a third total number of controls with unknown implementation statuses are calculated.

In an embodiment, the system includes a memory and a processor in communication with the memory. The processor configurable to receive a selection of criteria for compliance level calculation, wherein the criteria include at least one regulation. At least one control applicable for the regulation is determined, the control defined with a required implementation level for the regulation in a requirements matrix. The processor is also configurable to determine an implementation status of the control for the regulation. Further, it is determined if the implementation status of the control corresponds to the required implementation level for the regulation. Finally, in response to the determination if the implementation status corresponds to the required implementation level, a first total number of compliant controls, a second total number of non-compliant controls, and a third total number of controls with unknown implementation statuses are calculated.

These and other benefits and features of embodiments of the invention will be apparent upon consideration of the following detailed description of preferred embodiments thereof, presented in connection with the following drawings.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a block diagram illustrating a typical control management structure.

FIG. 2 is a block diagram illustrating a requirements matrix of merged control management solutions.

FIG. 3 is a table illustrating an exemplary requirements matrix.

FIG. 4 is a block diagram illustrating enterprise control management system.

FIG. 5 is a flow diagram illustrating the method of calculating requirements fulfillment for a group of controls.

FIG. 6 is a table illustrating an exemplary requirements matrix with a plurality of standards and controls.

FIG. 7 is an exemplary screenshot illustrating criteria selection for compliance level calculation.

FIG. 8 is a bar chart illustrating an exemplary compliance report to security standards 710.

FIG. 9 is a pie chart illustrating an exemplary average compliance report to the selected security standards 710.

FIG. 10 is a block diagram illustrating an exemplary computer system 1000.

### DETAILED DESCRIPTION

Embodiments of techniques for methodology for determination of the regulatory compliance level are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiment.

A methodology and control management solution is described with the following qualities: effectiveness of operation, efficiency of required resources, and ability for quick adjustments. The measurement of compliance status in percents is a good key performance indicator (KPI). The usage of this KPI shows changes on the compliance status in different areas, allows derivation of compliance trends, and allows comparison between different areas. Compliance is obedience to some regulations. These could be law regulations, international standards, or internal policies of an enterprise. The measurement of compliance often includes enclosure of measured area like country or organization, and regulatory act like ISO27001:2005.

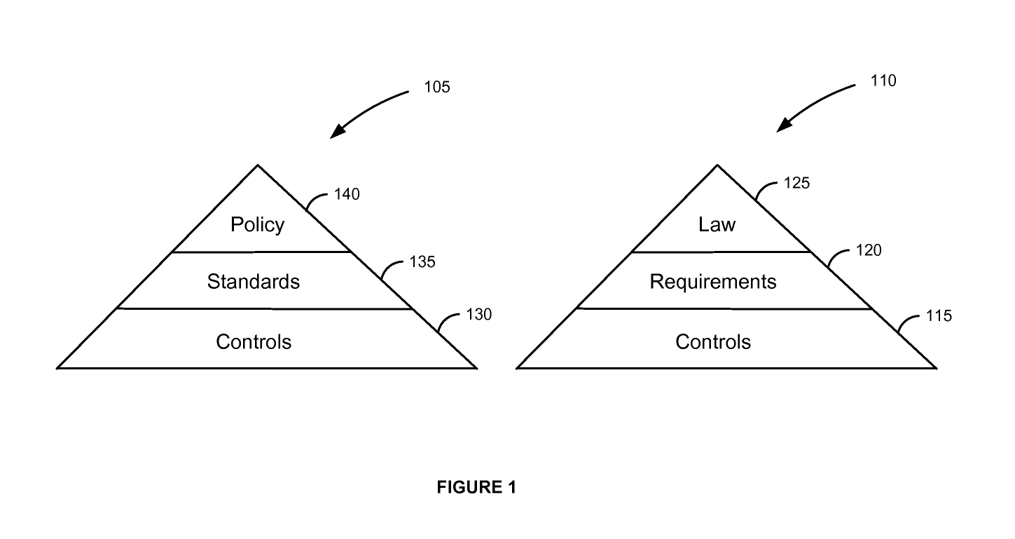

FIG. 1 is a block diagram illustrating a typical control management structure. Compliance calculation is usually based on controls that belong to one specific standard or regulation such as SOX controls. A control is a continuous process with the aim to reach or keep some goal or condition. Such goals are usually derived from business requirements or even compliance requirements. There are several types of business controls including but not limited to financial, risk management, security controls, etc. To determine the status of controls, a separated control testing or an audit is required. These processes use complex control descriptions and simple (yes/no) rating for control states. Consecutively, trained employees and a lot of administrative effort are required. For each calculation of the compliance level, separated testing has to be performed, e.g., compliance to Data Protection Law, to TKG, or to Enterprise Security Policy. This approach leads to various separate solutions for control management at an enterprise. Even if the same IT system is used, different control bundles have no relation to each other. Due to this fact, separated audits for each control bundle is required.

Systems 105 and 110 illustrate two different solutions for control management based on two different areas (e.g., system 105 illustrates solution for enterprise security compliance and system 110 illustrates solution for law compliance). System 110 includes controls 115 as the basis for the control management solution. The description of each control from controls 115 is bounded on one requirement from requirements 120. This control can be used for this requirement only. On top of requirements 120 is law 125. Law 125 is interpreted by the requirements 120 that are mapped to controls 115. At the same time the set of controls 115, e.g., in security or IT operational area, have to fulfill different requirements of different laws or standards. For example, a control such as data backup is related to SOX, TKG, COBIT, ISO, and an internal IT Standard. These regulations may have different requirement for data backup implementation. Currently, it is very time consuming to give a statement about fulfillment of all these regulations by the conditioned control. System 105 includes another set of controls 130 but for a different area. The set of controls 130 is mapped to a set of standards 135. The set of standards is mapped to policy 140. The policy 140 is specified by the set of standards 135, which is specified by the set of controls 130. The solutions are applicable for just one law or one policy respectively. For a given control, the effort to get the status of this control is very high and the effort to get the status of fulfillment of each requirement by this control is extremely high.

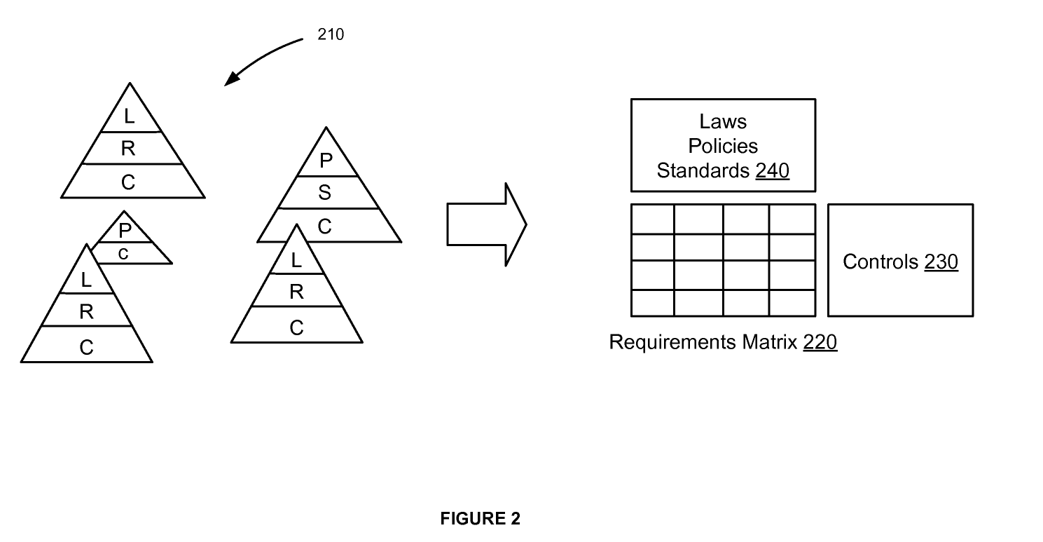

FIG. 2 is a block diagram illustrating a requirements matrix of merged control management solutions. In various embodiments, a central control management system is created for compliance calculation by various criteria such as regulatory, organization, country, business area, control or control set, time frame, and so on. Such system can replace all locally existing compliance systems and use synergies by controls definition for the effective operation. In an embodiment, multiple control management solutions 210 (such as 105 and 110) are merged into a requirements matrix 220. The requirements matrix 220 includes all controls 230 from the multiple control management solutions 210 and all laws, policies, and standards 240 from the multiple control management solutions 210. Via the requirements matrix 220, controls 230 are mapped to laws, policies, and standards 240. This is performed via multiple-to-multiple relationships, meaning that one control from controls 230 can be related to different laws, policies, and standards 240 at the same time. Thus, for each control, the compliance of the different laws, policies, and standards can be tracked.

One control is often related to different regulations. A lot of effort by determination of a compliance level can be saved, if there is only one statement about the implementation status of a control, and based on that, decide about fulfillment of different requirements. A more efficient way is to collect the control status, without thinking about requirements, and automatically determine requirements fulfillment. In various embodiments, an enlarged scale with possible implementation states for each control is defined. Such scale may simplify the statement about the status of control and allow it without requirements consideration. Also the enlarged implementation scale enables to set up relations of different implementation levels to different regulatory requirements.

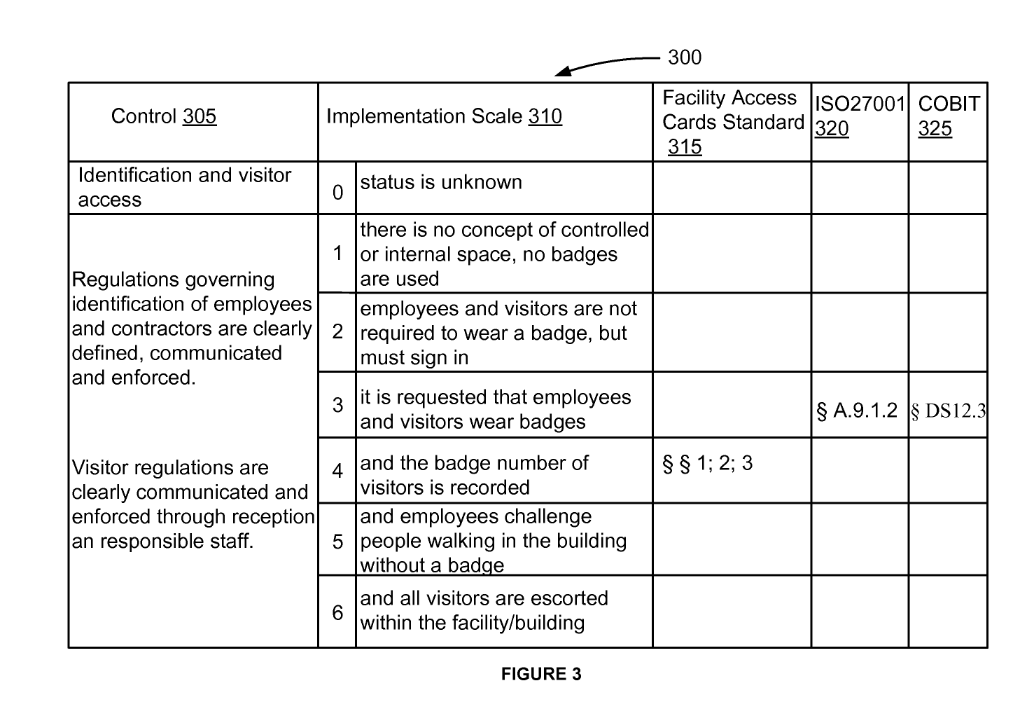

FIG. 3 is a table illustrating an exemplary requirements matrix. Table 300 shows an exemplary control management solution including security control 305 with defined implementation scale 310 and their relation to the internal Facility Access Cards 315, ISO27001 320, and COBIT 325 standards. Control 305 represents a security control for identification and visitor access to a building of a company. Regulations governing identification of employees and contractors are clearly defined, communicated, and enforced. Visitor regulations are clearly communicated and enforced through reception and responsible levels of staff. Implementation scale 310 includes a scale from 0 to 6 representing different levels of implementations of control 305 as statuses. Implementation level 0 specifies that the status is unknown. In this case a message is returned that this control was considered but its status is not determined. This information is also important for a compliance level calculation.

Implementation level 1 specifies that there is no concept of controlled or internal space, no access badges are used Implementation level 2 specifies that employees and visitors are not required to wear a badge, but must sign in at the reception. Implementation level 3 specifies that it is required that employees and visitors wear badges. Implementation level 4 is an upgrade of implementation level 3 and specifies that it is required that employees and visitors wear badges and the badge number of visitors is recorded Implementation level 5 is an upgrade of implementation level 4 and specifies that employees challenge people walking in the building without a badge Implementation level 6 is an upgrade of implementation level 5 and specifies that all visitors are escorted within the building.

The link between regulation and required implementation level of control takes place by level selection and specification of a given requirement. In the exemplary table 300, to meet requirements described in §1-3 of Facility Access Card Standard (FACS) 315, Identification and Visitor Access control 305 has to be implemented with level 4 or higher. In this level, the requirements of ISO27001 320 and COBIT 325 are also fulfilled Implementation with level 3 meets only ISO27001 320 and COBIT 325 requirements, but not FACS 315 requirements. The extracted and formulated regulation requirement can be also linked to the link between regulation and implementation level or specified directly in the link description. The described requirement matrix allows both: control based evaluation and calculation of compliance level to the specific regulation. In the first case, it can be seen which requirements are fulfilled by a specific control and which are not. In the second case, all controls related to specific regulatory are selected and then the fulfillment of all requirement for this regulatory can be calculated. Although table 300 includes just one control 305, multiple controls can be defined in the requirement matrix for control based evaluation and calculation of the compliance level.

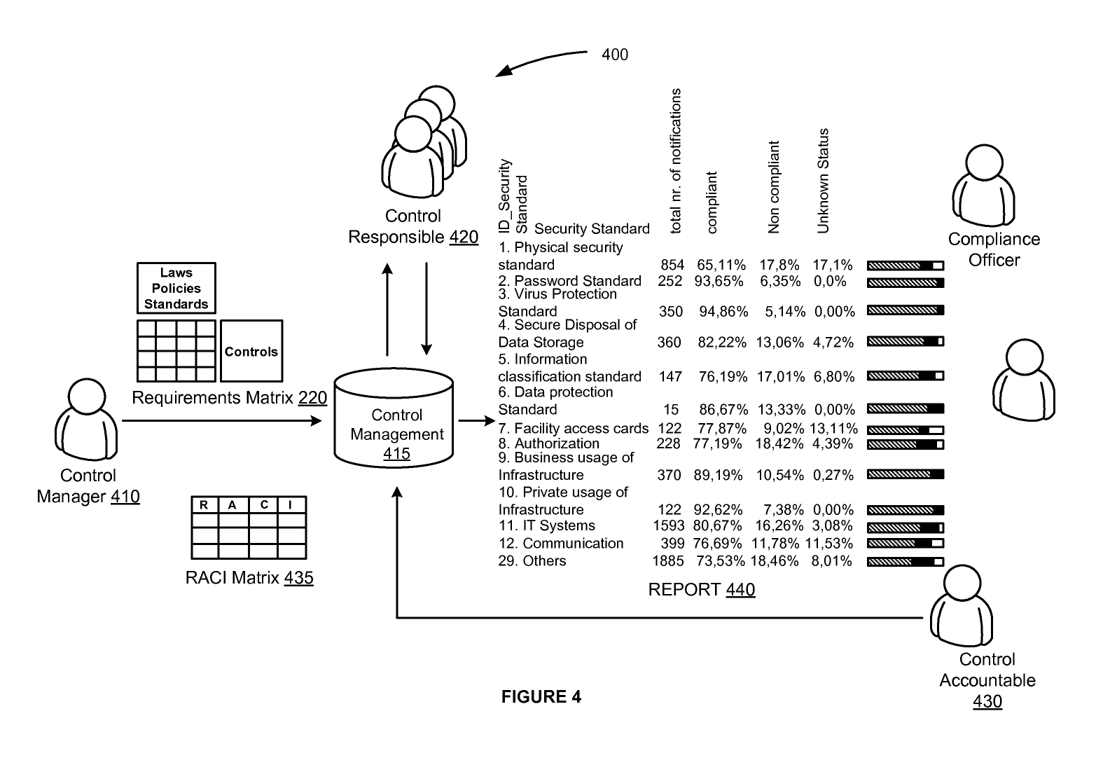

FIG. 4 is a block diagram illustrating enterprise control management system. System 400 illustrates the processes for enabling an operation of central control management solution including: definition and maintenance of controls and requirements matrix, communication of controls and collection of their implementation status, and the compliance calculation process. Considering these processes for definition of controls and compliance requirements, status collection, and compliance calculation, three role types can be extracted: control manager 410, control responsible 420, and Compliance Officer, Auditor or Control Accountable 430. Control manager 410 defines the controls, maps them to regulatory requirements, and defines a responsibility assignment matrix (RACI) 435. The RACI describes participation by various roles in completing different tasks or deliverables for a project or a business process. Further, control manager 410 operates with control, requirements, laws, policies, standards and creates requirements matrix 220. The requirement matrix 220 is stored in control management 415.

Control responsible 420 is responsible for control operation and provides the status of a control implementation, i.e. reporting, by selection of the relevant implementation level in the requirements matrix 220. The requirements matrix 220 is obtained from control management database 415. The control responsible 420 operates with controls only. Compliance Officer, Auditor or Control Accountable 430 uses a whole data collection (logical setup and reported status) for a calculation of the compliance level in selected areas and generating report 440. He or she operates with laws, policies, or standards. The control accountable also supports the definition of the RACI matrix, which provides the information about control responsibilities. In an embodiment, the control accountable specifies the control responsible 420 that provides the status of the control implementations.

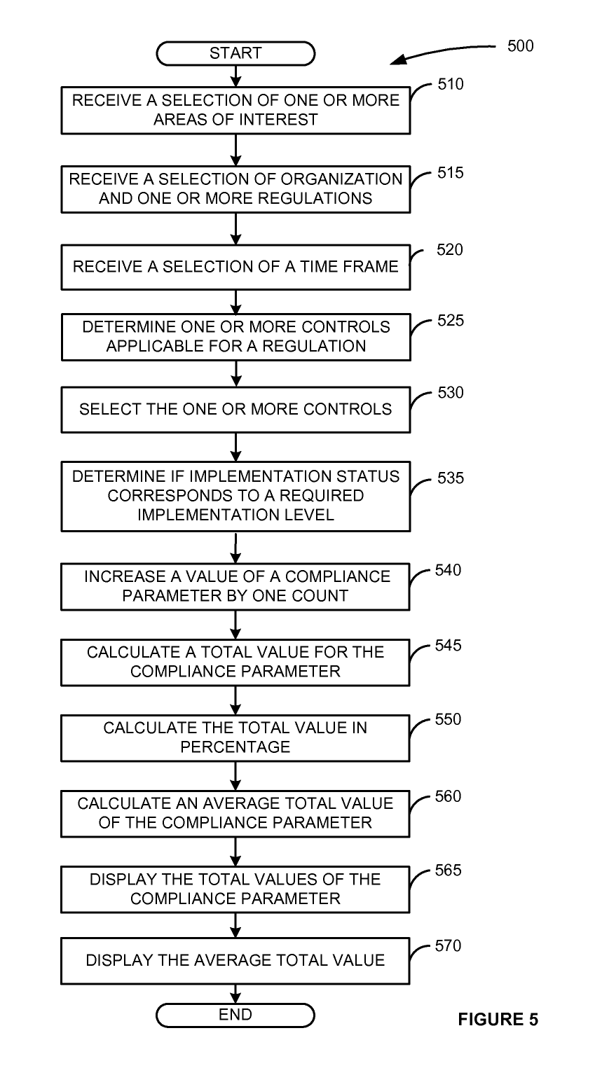

FIG. 5 is a flow diagram illustrating the method of calculating requirements fulfillment for a group of controls. In an embodiment, the method for calculating requirements fulfillment for a group of controls 500 is implemented in a system that includes a user interface tool that collects data, the system performs the calculation on the data and displays a report in the user interface. To perform a given analysis, some initial criteria have to be provided. At block 510, a selection of a particular area of interest or a group of areas is received for the analysis. In an embodiment, the area may be a geographical area, in another embodiment, the area may be a business area of interest, and so on. At block 515, a selection of a specific organization is received for the area and a selection of one or more standards for which the compliance should be calculated is also received. At block 520, a selection of a time frame for which the compliance should be calculated is received for the analysis.

In various embodiments, a database table contains a catalogue of controls, a catalogue of regulations, and mappings between both of them. This table provides a detailed specification of control-regulatory relation. Additionally, regulations could be grouped by category. In this way, e.g., a security policy can be defined as category and all included security standards as regulations. Responsibilities for controls per organization and country or organization and location have to be defined via the RACI matrix. Assigning of names to defined roles is a separate process, which has to be performed by control accountable from Compliance Officer, Auditor or Control Accountable 430.

At block 525, the method determines one or more controls that are defined and applicable for the chosen criteria from a plurality of controls. The one or more controls should be defined and applicable for the selected area, organization, one of the selected regulations (standards), and time frame. The plurality of controls is defined and stored in the requirements matrix in control management 415 database. For each control, a required implementation level per standard is defined. The implementation levels are part of implementation scale 310. At block 530, the determined one or more controls are selected. The one or more controls have implementation statuses assigned and stored in the requirements matrix. An implementation status represents the implemented compliance level for a given control. The implementation statuses are defined by the control responsible 420.

At block 535, the implementation status of a first control from the one or more controls for a considered standard is determined if it corresponds to the required implementation level defined in the requirements matrix. For example, the considered standard requires implementation level 3 and the selected first control has implementation status (i.e., implemented compliance level) 2, i.e., the control has a lower implementation status than the required implementation level for this standard. At block 540, the value of a countable compliance parameter is increased by one count according to the result of the determination. If the implementation status is lower than the required implementation level, then the value of a first compliance parameter is increased by one count. The first compliance parameter indicates that the implementation status of the selected first control is not compliant with the required implementation level. If the implementation status is the same or higher than the required implementation level, then the value of a second compliance parameter is increased by one count. The second compliance parameter indicates that the implementation status of the selected first control is compliant with the required implementation level. If the implementation status is unknown, then the value of a third compliance parameter is increased by one count. The third compliance parameter indicates that the implementation status of the selected first control is unknown.

The process of determining if the implementation status meets the required implementation level and increasing the corresponding compliance parameter is repeated for rest of the selected controls for the chosen standard. At block 545, a total value of the compliance parameter is calculated. The total value includes the total number of counts with which the compliance parameter was increased. The total value is calculated based on all selected controls. The total values for the first, second, and third compliance parameters are calculated according to the compliance of the different controls to the chosen standard. For example, the total value of the first compliance parameter=10, the total value of the second compliance parameter=5, and the total value of the third compliance parameter=10 means that for the chosen standard there are a total number of 10 compliant controls, 5 non-compliant controls, and 10 controls with unknown statuses. At block 550, the total value of the compliance parameter is calculated in percentage. Accordingly, the total values for the first, second, and third compliance parameters are calculated in percentage.

If this algorithm is performed with different time frames, the history and trends of compliance level changes can be visualized. In various embodiments, the compliance level of the selected one or more controls to a policy consisting of a plurality of standards is calculated. If more than one regulation (standard) is selected, the process of blocks 525-550 is repeated for all selected standards. As a result, a plurality of total values of the compliance parameter is calculated for the plurality of selected standards of a policy. At block 560, an average total value of the compliance parameter is calculated for the one or more selected standards providing average compliance information such as an average number of compliant standards in the policy, an average number of non-compliant standards in the policy, and an average number of standards with unknown statuses of the controls. At block 565, the total values of the compliance parameter of the selected controls for the selected one or more standards are displayed. In some embodiments, the total values of the compliance parameter for the selected one or more standards are displayed as a number, in other embodiments the total values are displayed as a chart bar in percentages, in third embodiments may be displayed with other visual elements, and so on. At block 570, the average total value is displayed via UI elements.

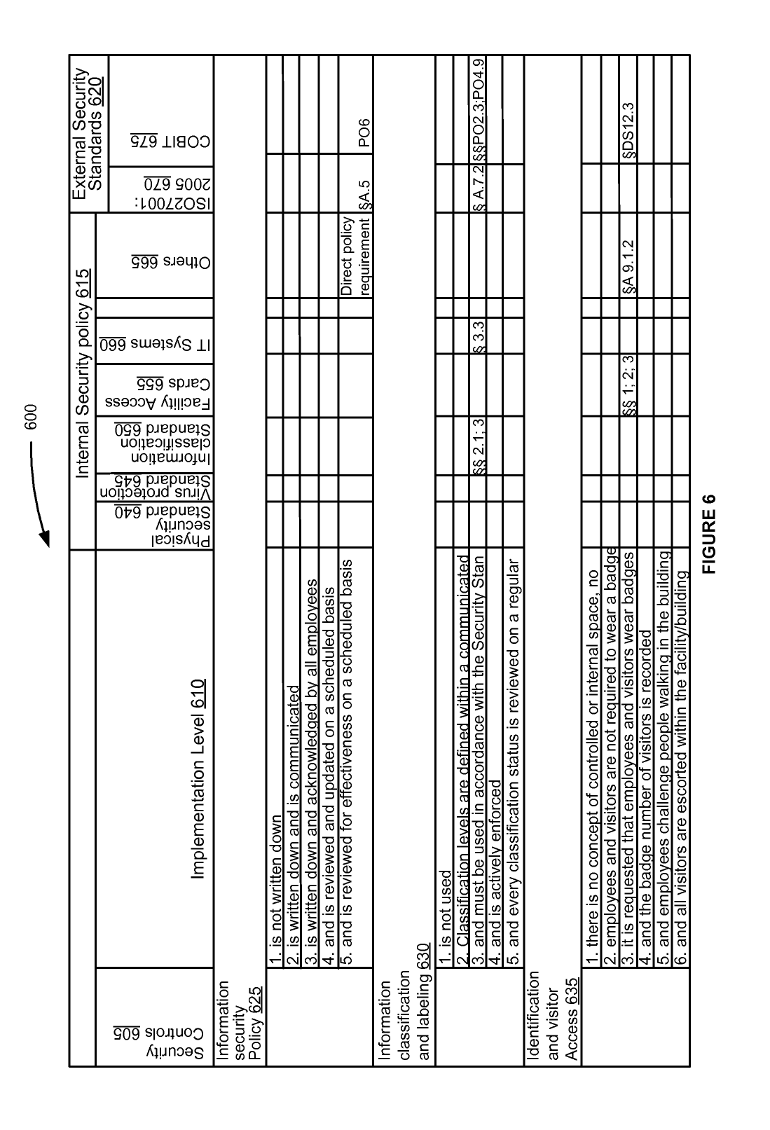

FIG. 6 is a table illustrating an exemplary requirements matrix with a plurality of standards and controls. Requirements matrix 600 is defined and stored in the control management database. Requirements matrix 600 includes a set of security controls 605, implementation level 610, internal security policy 615, and external security standards 620. Security controls 605 include the following controls: information security policy 625, information classification and labeling 630, and identification and visitor access 635. For information security policy 625 and information classification and labeling 630 controls, five implementation levels are defined. For identification and visitor access 635, six implementation levels are defined. Internal security policy 615 includes a set of security standards such as physical security standard 640, virus protection standard 645, information classification standard 650, facility access cards 655, IT systems 660, and others 665. External security standards 620 also include a set of security standards such as ISO27001:2005 670 and COBIT 675. For each security control, the requirements matrix 600 shows which implementation level should be implemented, so that the requirements specified in a security standard (external or internal) are fulfilled. For example, information security policy 625 should be implemented with level 5, so that the §Λ.5 of ISO27001:2005 670 standard and §P06 of the COBIT 675 standard are fulfilled. In various embodiments, the requirements matrix 600 is obtained by the control responsible 420 from the control management 415 and implementation statuses are assigned for the different controls 605.

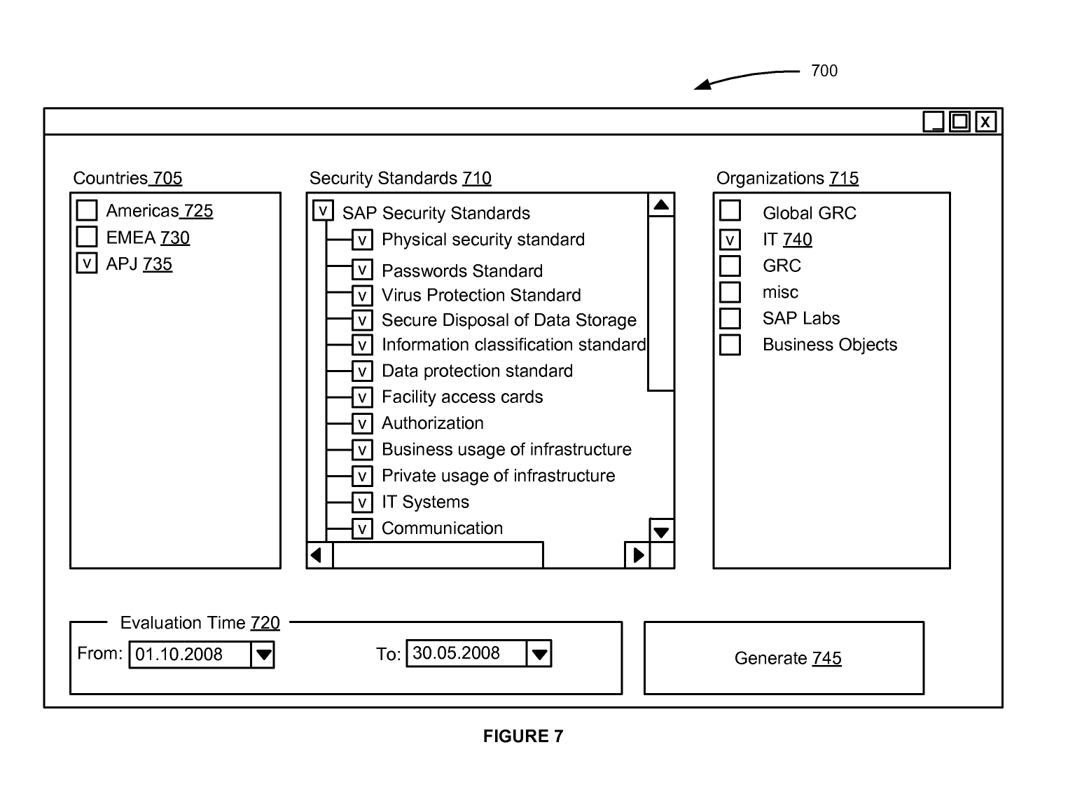

FIG. 7 is an exemplary screenshot illustrating criteria selection for compliance level calculation. In various embodiments, the compliance level calculation is implemented in an application performing tasks such as reporting, compliance analysis, etc., on the requirements matrix. Screenshot 700 illustrates criteria selection for compliance level calculation on requirements matrix 600.Screenshot 700 is part of an application for compliance analysis including a set of user interfaces. Screenshot 700 includes criteria such as countries 705, security standards 710, organizations 715, and evaluation time 720. Countries 705 represent areas of interest and include geographical areas such as Americas 725 (e.g., North America and South America), EMEA 730 (Europe, Middle East, and Africa), APJ 735 (Asia, Pacific, Japan), etc. In the exemplary scenario, APJ 735 is selected. In an embodiment, the selected area can be expanded to show all countries listed in the area for a narrow selection. Security standards 710 contain a list of all security standards included in internal security policy 615 and external security standards 620 of the requirements matrix 600. The user, such as Compliance Officer, Auditor or Control Accountable 430, can select which security standards he or she wants to analyze. Organizations 715 contain a list of possible organizations that can be analyzed. In the exemplary scenario, IT organization 740 is selected. Evaluation time 720 represents a time period for which the compliance evaluation report will be generated. When all necessary criteria are specified, the user can press Generate 745 button to generate the analysis report based on the selected criteria. In response to pressing the Generate button 745, a query including the selected criteria is generated and sent to the control management 415 for execution. Control management 415 performs process 500 to calculate the compliance level of the controls, applicable to the selected criteria, to the selected standards.

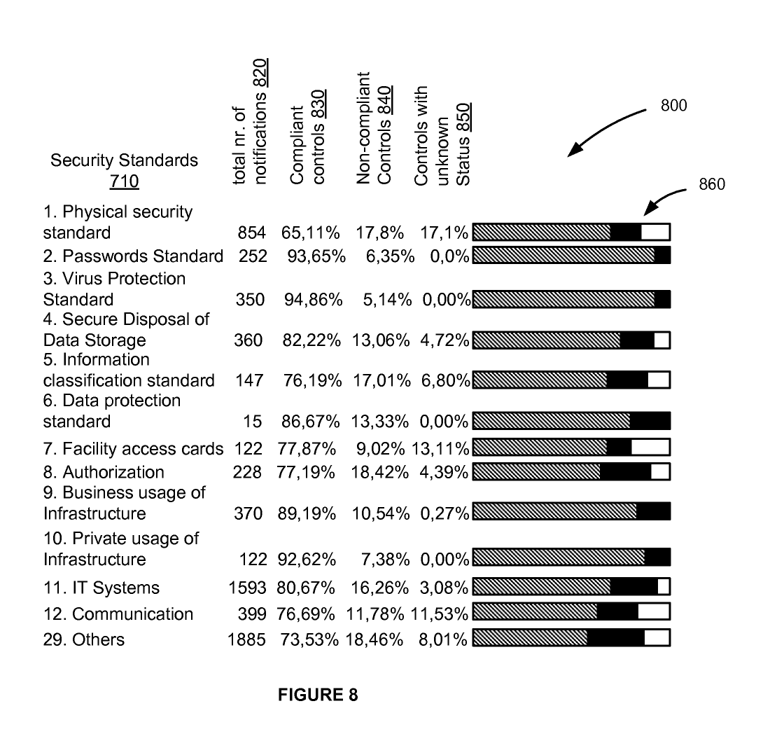

FIG. 8 is a bar chart illustrating an exemplary compliance report to security standards 710. Report 800 represents a generated compliance analysis report based on the selected criteria in screenshot 700 and the requirements matrix 600, including the selected security standards 710. Per each standard, a total number 820 of notifications is calculated, representing the total number of calculations of controls compliancy. Further, for each standard, the percents of compliant controls 830, non-compliant controls 840, and controls with unknown statuses 850 are calculated. In addition, the percents distribution is displayed in a UI bar 860 for better visualization.

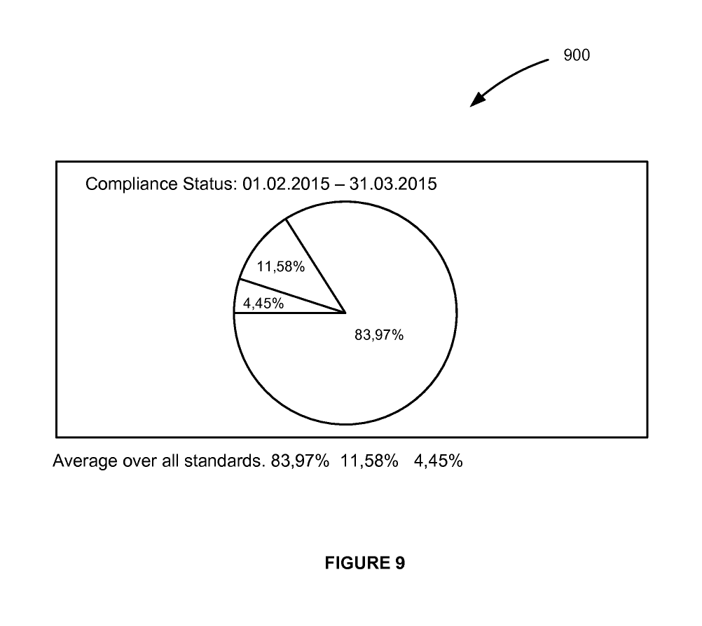

FIG. 9 is a pie chart illustrating an exemplary average compliance report to the selected security standards 710. Report 900 illustrates the average compliance of the controls over all selected security standards 710. Report 900 shows that 83.97% of the applicable controls are complaints with selected standards 710, 11.58% are non-compliant, and 4.45% are controls with unknown status. Report 900 also shows the specified evaluation time 720 period for the report.

The measurement of compliance status demands in most cases interpretation of regulations and their refinement. Prepared by the governance department and distributed by responsible organizations, this information helps for better understanding of required controls, their details, and makes a fine granular reporting about the status of control implementation possible. Ones introduced, presented methodology allows flexible compliance calculation, which can be used on all organization levels in a company for self assessments or KPI measurement. On a global level an extended analysis is enabled for, e.g., history, trends, and drill down analysis.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

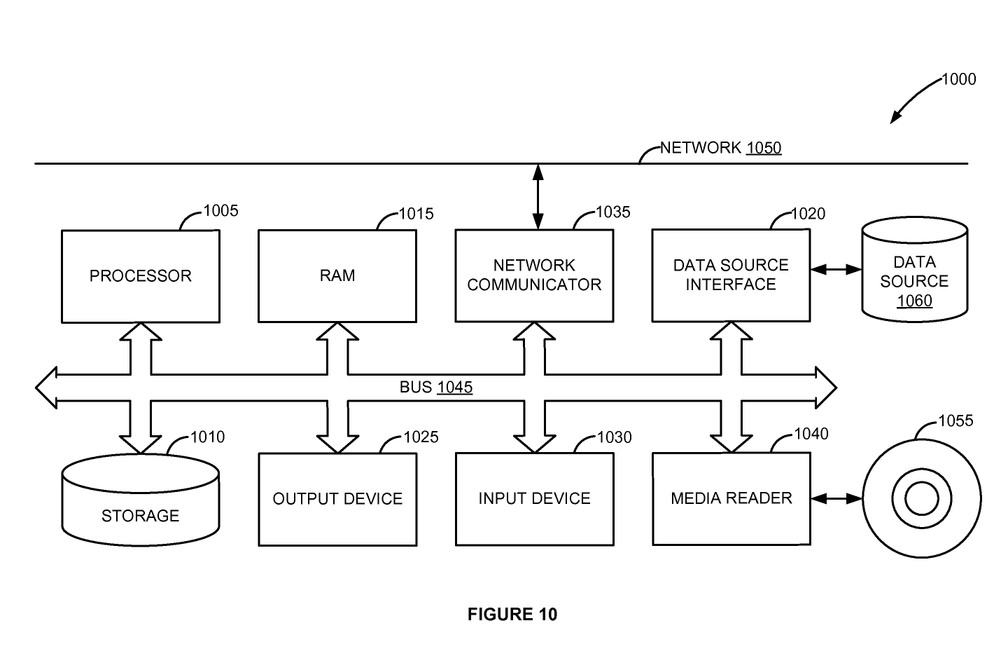

FIG. 10 is a block diagram illustrating an exemplary computer system 1000. The computer system 1000 includes a processor 1005 that executes software instructions or code stored on a computer readable storage medium 1055 to perform the above-illustrated methods of the invention. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment of the invention, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be access via one or more abstraction layers implemented in hardware or software. For example, the data source 1060 may be access by network 1050. In some embodiments the data source 1060 may be accessed via an abstraction layer, such as, a semantic layer.

A data source 1060 is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

What is claimed is:

1. An article of manufacture including a tangible computer readable storage medium to physically store instructions, which when executed by a computer, cause the computer to:
receive a selection of criteria for compliance level calculation, wherein the criteria include at least one regulation;
determine at least one control applicable for the regulation, the control defined with a required implementation level for the regulation in a requirements matrix;
determine an implementation status of the control for the regulation; and
determine if the implementation status of the control corresponds to the required implementation level for the regulation; and
in response to the determination if the implementation status corresponds to the required implementation level, calculate a first total number of compliant controls, a second total number of non-compliant controls, and a third total number of controls with unknown implementation statuses.

2. The article of manufacture of claim 1, wherein the instructions further cause the computer to:
increase a value of a first compliance parameter by one count if the implementation status of the control is same or higher than the required implementation level;
increase a value of a second compliance parameter by one count if the implementation status of the control is lower than the required implementation level; and
increase a value of a third compliance parameter by one count if the implementation status of the control is unknown.

3. The article of manufacture of claim 2, wherein the first total number is calculated based on the first compliance parameter, the second total number is calculated on the second compliance parameter, and the third total number is calculated based on the third compliance parameter.

4. The article of manufacture of claim 1, wherein the instructions further cause the computer to:
calculate the first total number, the second total number, and the third total number in percentage; and
display the first total number, the second total number, and the third total number in a report.

5. The article of manufacture of claim 1, wherein the instructions further cause the computer to:
calculate a first average number of compliant controls for a plurality of regulations;
calculate a second average number of non-compliant controls for the plurality of regulations; and
calculate a third average number of controls with unknown implementation statuses for the plurality of regulations.

6. The article of manufacture of claim 1, wherein the instructions that cause the computer to receive the selection of criteria further cause the computer to:
receive a selection of an area of interest;
receive a selection of an organization; and
receive a selection of a time frame.

7. The article of manufacture of claim 1, wherein the implementation status represents an implemented compliance level of the control.

8. A computerized method comprising:
receiving a selection of criteria for compliance level calculation, wherein the criteria include at least one regulation;
determining at least one control applicable for the regulation, the control defined with a required implementation level for the regulation in a requirements matrix;
determining an implementation status of the control for the regulation; and
determining if the implementation status of the control corresponds to the required implementation level for the regulation; and
in response to determining if the implementation status corresponds to the required implementation level, calculating a first total number of compliant controls, a second total number of non-compliant controls, and a third total number of controls with unknown implementation statuses.

9. The method of claim 8, further comprising:
increasing a value of a first compliance parameter by one count if the implementation status of the control is same or higher than the required implementation level;
increasing a value of a second compliance parameter by one count if the implementation status of the control is lower than the required implementation level; and
increasing a value of a third compliance parameter by one count if the implementation status of the control is unknown.

10. The method of claim 9, wherein the first total number is calculated based on the first compliance parameter, the second total number is calculated on the second compliance parameter, and the third total number is calculated based on the third compliance parameter.

11. The method of claim 8, further comprising:
calculating the first total number, the second total number, and the third total number in percentage; and
displaying the first total number, the second total number, and the third total number in a report.

12. The method of claim 8, further comprising:
calculating a first average number of compliant controls for a plurality of regulations;
calculating a second average number of non-compliant controls for the plurality of regulations; and
calculating a third average number of controls with unknown implementation statuses for the plurality of regulations.

13. The method of claim 8, further comprising:
receiving a selection of an area of interest;
receiving a selection of an organization; and
receiving a selection of a time frame.

14. The method of claim 8, wherein the implementation status represents an implemented compliance level of the control.

15. A computing system comprising:
a memory; and
a processor in communication with the memory, the processor configurable to:
receive a selection of criteria for compliance level calculation, wherein the criteria include at least one regulation;
determine at least one control applicable for the regulation, the control defined with a required implementation level for the regulation in a requirements matrix;
determine an implementation status of the control for the regulation; and
determine if the implementation status of the control corresponds to the required implementation level for the regulation; and
in response to the determination if the implementation status corresponds to the required implementation level, calculate a first total number of compliant controls, a second total number of non-compliant controls, and a third total number of controls with unknown implementation statuses.

16. The computing system of claim 15, further comprising:
a first compliance parameter, which value is increased by one count if the implementation status of the control is same or higher than the required implementation level;
a second compliance parameter, which value is increased by one count if the implementation status of the control is lower than the required implementation level; and
a third compliance parameter, which value is increased by one count if the implementation status of the control is unknown.

17. The computing system of claim 15, further comprising a user interface to display the first total number, the second total number, and the third total number in a report.

18. The computing system of claim 16, wherein the first total number is calculated based on the first compliance parameter, the second total number is calculated on the second compliance parameter, and the third total number is calculated based on the third compliance parameter.

19. The computing system of claim 15, further comprising:
a first average number of compliant controls calculated for a plurality of regulations;
a second average number of non-compliant controls calculated for the plurality of regulations; and
a third average number of controls with unknown implementation statuses calculated for the plurality of regulations.

20. The computing system of claim 15, wherein the criteria includes at least an area of interest, an organization, and a time frame.
